(19) United States
(12) Patent Application Publication
(10) Pub. No.: US 2015/0218811 A1
(43) Pub. Date: Aug. 6, 2015

(54) MULTI-PLY PANEL

(71) Applicants: Laurent Bourdon, Seynod (FR); Pascal Faure, Ugine (FR); Didier Goy, Manigod (FR); Christian Chabrier, Ma Balme de Thuy (FR)

(72) Inventors: Laurent Bourdon, Seynod (FR); Pascal Faure, Ugine (FR); Didier Goy, Manigod (FR); Christian Chabrier, Ma Balme de Thuy (FR)

(73) Assignee: TECHNIWOOD INTERNATIONAL, Maxeville (FR)

(21) Appl. No.: 14/389,876

(22) PCT Filed: Apr. 11, 2012
(86) PCT No.: PCT/FR2012/050781

§ 371 Date: Oct. 14, 2014

(30) Foreign Application Priority Data
Apr. 4, 2012 (FR) 12 53080

(51) Int. Cl. E04C 2/296; B32B 3/10

(52) U.S. Cl. CPC E04C 2/296; B32B 3/10; B32B 2305/30; B32B 2307/304; B32B 2307/102; B32B 2307/3065; B32B 2607/00; B32B 2419/00

(57) ABSTRACT

The multi-ply panel for forming or adding to a wall, floor, or ceiling, or for the inclined surface of a building includes a stack of layers. At least one layer is formed of parallel structural strips, preferably made of wood. Filler strips are placed between the structural strips and made of a different material than that of the structural strips. The materials may be selected for the heat or sound insulation properties, thermal inertia, or fire-resistant properties thereof. At least one rigid filler strip is made of an insulating material with heat conductivity less than 0.038 W/m·K.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention is related to the construction of buildings. It relates in particular to a panel for forming a floor or a wall or an inclined roof, or also for forming an addition for a wall, for example in order to improve its heat and/or sound insulation, or its fire-resistance.

2. Description of Related Art Including Information Disclosed Under 37 CFR 1.97 and 37 CFR 1.98.

Many materials have been proposed for forming walls or additions for walls, in order to improve their heat and/or sound insulation, or their fire-resistance. With the entering into force of new standards RT 2012, RT 2020 to come and labels, the requirements change, and it is therefore necessary to be able to provide qualities for different walls or complements for walls. In addition, the necessary quality is not the same for inner or outer walls, ceilings, inclined roofs, and depending on the type of construction, the requirements change too. This obliges the provider of panels or materials to provide a large amount of references in order to be able to meet all the needs.

### SUMMARY OF THE INVENTION

The aim of the present invention is to cope at least partially with these drawbacks. To this end, it provides a multi-ply panel for forming or as an addition for a wall, a floor or a ceiling, or an inclined surface of a building, formed of a stack of layers, at least one of which is formed of parallel structural strips, preferably made of wood, and filler strips arranged between the structural strips and made of a different material than that of the structural strips, whereby said materials can be selected for their heat or sound insulation, their thermal inertia or fire-resistance. The panel is particular in that at least one filler strip is made of an insulating material with a heat conductivity of less than 0.038 W/mK, preferably of less than 0.035 W/mk.

Thanks to these arrangements, a plurality of types of panels can be obtained, with features adapted to every need, through a simple design and improved efficiency, in particular in terms of heat insulation.

According to further features

said insulating material can be glass wool, rock wool, or white or graphite expanded polystyrene, materials possessing good heat-insulation properties,

said panel can comprise a strip made of an inertia material having a thermal inertia higher than 1000 kJ/m³·K; this arrangement permits to impart a good thermal inertia to said panel, cooling less quickly during the night and/or in winter, and heating less quickly during daytime and/or in summer, and said strip can advantageously be arranged on the side of the wall closest to the interior of a building, thus providing the users with maximum comfort.

said material can be wood, plaster, cellulose wadding or wood flakes, which exhibit a combination of specific heat and density, which provides good thermal inertia,

said panel can comprise a filler strip made of sound-insulation material,

said sound-insulation material can be rock wool or wood fibers, which materials are well suited for sound insulation

said panel can comprise a strip made of non-combustible material, providing said panel with good fire-resistance

said non-combustible material can be plaster or rock wool, which materials have a good fire-resistance; one will choose the one among the materials the other characteristics of which correspond best to what is desired for the panel,

said panel can comprise a ply for technical networks, in which spaces remain between structural strips, such as to permit the passing through of technical networks, thus permitting to hide said technical networks in the panel.

The advantage of the present invention resides in particular in that it permits to provide panels with adapted and improved properties for a plurality of applications, based on a small number of elementary components, which are the structural strips and the filler strips assembled into layers and wafers.

The present invention will be better understood when reading the following detailed description, with reference to the attached figures.

### BRIEF DESCRIPTION OF THE DRAWINGS

FIG. 1 is an exploded perspective view of a wood lattice of a panel according to the invention.

FIG. 2 is a sectional view of the assembled wood lattice of FIG. 1.

FIG. 3 is an exploded sectional view of a partial panel according to the invention.

FIG. 4 is a front elevation view of a second embodiment of a layer of a panel according to the invention.

FIG. 5 is a front elevation view of a third embodiment of a layer of a panel according to the invention.

### DETAILED DESCRIPTION OF THE DRAWINGS

The panels are comprised of a succession of plies 1, also referred to as layers. Each ply can comprise structural strips 2 and filler strips 3. The filler materials are generally classified into soft materials, semi-rigid materials, comprised of soft materials associated with a Kraft paper or glass-fiber reinforcing, these two types of materials being often handled in the form of reels and rigid materials that stand alone and are handled in the form of plates. The filler strips of the present invention are generally rigid strips, but can be semi-rigid materials.

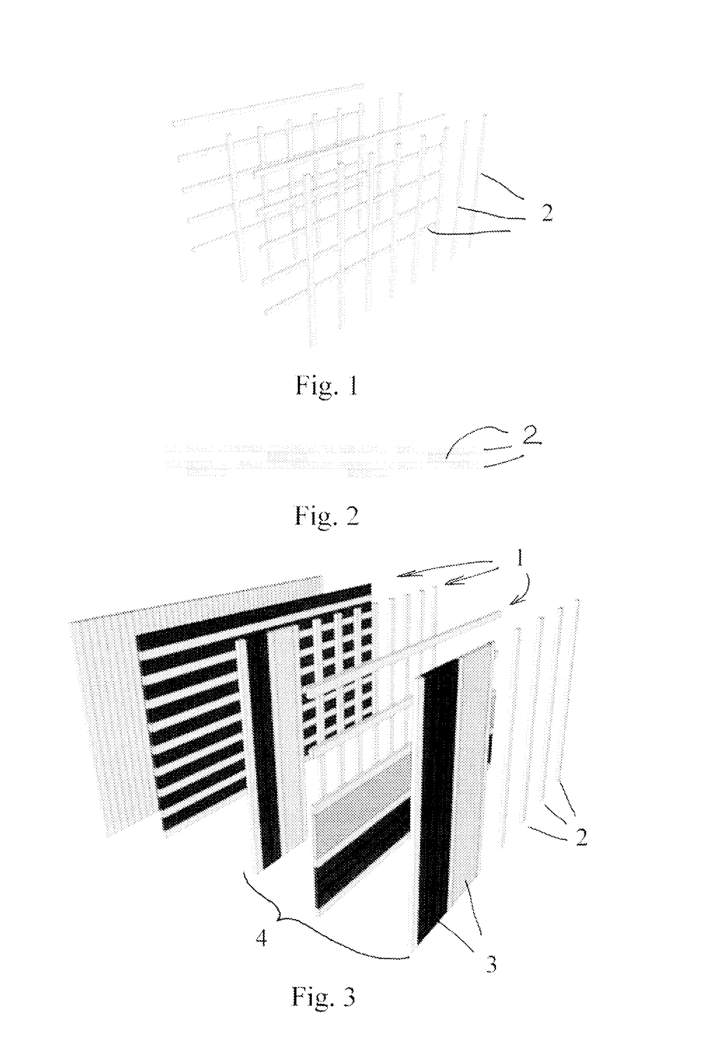

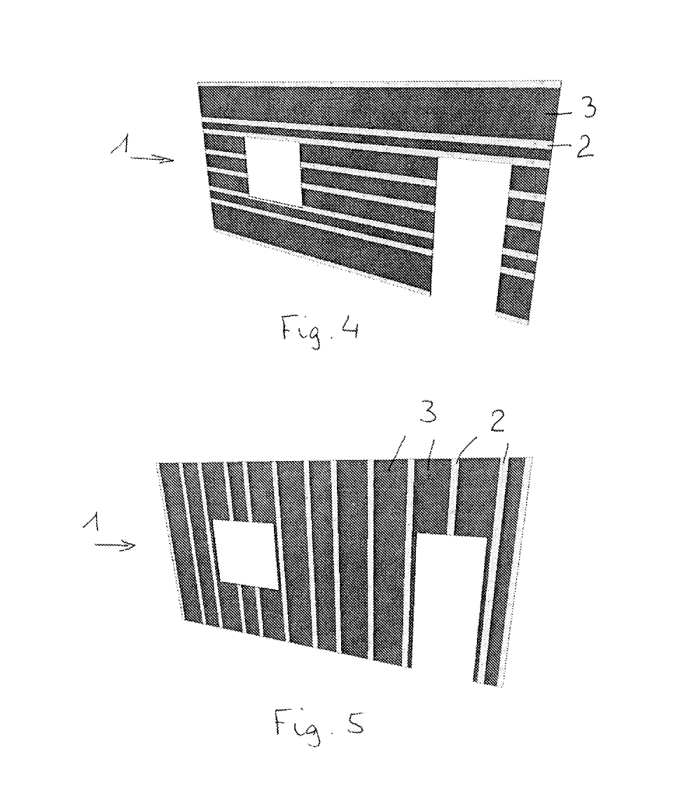

According to a first embodiment shown in FIGS. 1 to 3, the orientation and the arrangement of the structural strips 2 in the various layers 1 form a structure equivalent to a structural mesh. These structural strips can for example be abutting and sized, of a rectangular cross-section and arranged horizontally, then vertically every second layer. The intersecting layers are assembled together at the level of the wooden strips. This assembling can occur by gluing, or also by nailing or screwing. In FIG. 3 can be seen a structural layer comprised exclusively of structural strips.

The layers the structural strips of which are oriented in the same direction (vertically or horizontally) can have a shift in positioning of the structural strips of a layer on top of the other one. This shift reduces, even annihilates the thermal bridges potentially generated by the structural lattice.

According to another embodiment, two successive layers can be arranged with parallel structural strips, or also inclined according to any angle, e.g. 30°, 45° or 60° from one layer to another.

The structural strips can be made of wood, but also of metal, preferably a light metal such as aluminum, a composite material such as carbon fiber, or also of resin.

The overall mechanical strength of the panel is obtained through structural assembling of the structural strips with each other over their entire contact area: their entire length or the intersections of the strips depending on whether they are stacked, or they form an angle between them.

The shift (or distance between centers) between the structural strips depends on the expected mechanical strength of the layer, and between the structural strips can be arranged a number of filler strips, either of standard width, or of a width adapted to the geometrical constraints observed for the panel, for example the presence of doors or windows.

FIGS. 4 and 5 show two examples of layers incorporating a door 5 and a window 6, with two different arrangements of the structural strips. Thus, a layer according to FIG. 4 can be alternated with a layer according to FIG. 5, but several successive layers according to FIG. 4 can also be arranged, or other configurations, such as a layer formed of structural strips can be intercalated. The selected filler strips complete the layers.

Since the structural strips are oriented horizontally in a layer, the thickness of the layer is given by the thickness of the structural strips being chosen. The thickness of the structural strips can eventually vary from one layer to another; thus, a panel can be comprised of layers of different thicknesses.

Examples of possible dimensions of the structural panels:
30×100 mm,
30×150 mm,
45×95 mm,
45×145 mm.

Examples of possible dimensions of the filler strips (insulation, inertia or the like):
150 mm (the thickness being that of the wooden strip)
300 mm (or 2 strips of 150 mm)
450 mm (or 3 strips of 150 mm or 1 strip of 150 mm and one strip of 300 mm),
600 mm (or 4 strips of 150 mm or 2 strips of 300 mm)
any dimension imposed by the geometrical arrangement of the panel.

The spaces available between structural strips in each of the layers can be filled by a filler strip made of a suitable material or left empty (for example, for the outer layers) in order to integrate technical networks or for any other purpose.

Within a layer, the filler strips can be glued edge to edge, namely when several strips are associated, and glued to the structural strips, in order to achieve a perfect contact between materials, guarantee of good air, heat and acoustic tightness.

The various panels (walls, slabs, floors, inclined surfaces) must perform one or more functions within a building, while meeting regulatory requirements:

TABLE 1
Regulatory Requirements

| SERVICE | REQUIREMENTS |
|---|---|
| Structural | Eurocodes |
| Thermal | RT2005, RT2012, . . . |
| Acoustic | NRA2000 |
| Fire | Eurocodes |

The Thus, an accurate formulation adapted to each requirement, for each of the layers forming the panel, should lead to a rationalization of the materials used. The components present in the panels should be in a strictly necessary and sufficient quantity.

The analysis of these different formulations has permitted to identify the “functional wafers” 4 (FIG. 3) including a plurality of layers, which are in turn formed of various materials
Structural slab,
Insulating wafer,
Inertia wafer
Wafer for technical networks and facing support.

NOTE: each of the functional wafers can have minimum capacities for other functions (e.g. the structural wafer provides an initial response for the insulating function).

The various examples explained below are given based on layers each having a thickness of 30 mm.

### Example 1

### CURTAIN WALL Applied Against a Main Structure of Concrete, Metal or Wood for a New Building or a Renovation

Inner facing: Plasterboard.
Acoustic cavity-wall/service space: Metal rail of the type R48+sound insulation such as 50 mm mineral wool:
   R=1.40 m2·K/W
   Rw—17 dB (with BA13)
Vapor barrier: thickness>=150μ/Sd>80-100 m
Filler panel/thermal and acoustic roles (panel according to the invention)
   1st vertical layer—25% wood/75% mineral wool
   2nd horizontal layer—25% wood/mineral wool
   3rd vertical layer—25% wood/75% PSEG
   4th horizontal layer—25% wood/75% PSEG
   5th vertical layer—25% wood/75% PSEG
   6th horizontal layer—25% wood/75% PSEG
   7th vertical layer—25% wood/75% mineral wool
Rain screen: rain screen Sd<0.18 m
Facing support/ventilated air strip: solid wooden battens 30×80 mm (distance between centers 600 mm)
Outer facing: Laminated panels

The performances achieved with such a panel are the following:
Heat Resistance: 4.91 m²·K/W
Heat conductivity: 0.203 W/m²·K (the new RT2012 requires≦0.2 W/m2·K)
Acoustic resistance Rw 36 dB without BA13 (the NRA2000 requires 30 or 53 dB)
Acoustic resistance Rw 36 dB without BA13 (the NRA2000 requires 30 or 53 dB)

### Example 2

### Multi-Wafer Bearing Wall

Inner facing: Plasterboard.
Facing support/service space: solid wooden battens 37×50 mm (distance between centers 600 mm)
Vapor barrier: thickness>=150μ/Sd>80-100 m
Bearing panel/thermal, acoustic and structural roles (panel according to the invention):
Structural wafer:
   1st vertical layer—50% wood/50% mineral wool
   2nd horizontal layer—20% wood/80% PSEG
   3rd vertical layer—50% wood/50% PSEG
   4th horizontal layer—20% wood/80% PSEG
   5th vertical layer—50% wood/50% PSEG
insulating wafer:
   6th horizontal layer—20% wood/80% PSEG
   7th vertical layer—20% wood/80% PSEG
   8th horizontal layer—25% wood/75% mineral wool
Rain screen: rain screen Sd<0.18 m
Facing support/ventilated air strip: solid wooden battens 27×50 mm (distance between centers 600 mm)
Outer facing: wooden siding

The performance achieved with such a panel are the following:
Heat resistance: 5.03 m²·K/W
Heat conductivity: 0.198 W/m²·K (the new RT2012 requires 0.2 W/m2·K)
Acoustic resistance Rw 40 dB with BA13 (the NRA2000 imposes 30 dB)
Acoustic Rw 40 dB with BA13 (the NRA2000 requires 30 or 53 dB)

### Example 3

### Single-Wafer Bearing Wall

Inner facing: Plasterboard.
Facing support/service space: solid wooden battens 37×50 mm (distance between centers 600 mm)
Bearing panel/acoustic and structural roles (panel according to the invention)
   1st vertical layer—50% wood/50% mineral wool
   2nd horizontal layer—20% wood/80% PSEG
   3rd vertical layer—50% wood/50% PSEG
   4th horizontal layer—20% wood/80% PSEG
   5th vertical layer—50% wood/50% mineral wool
Inner facing: Plasterboard

The performance achieved with such a panel are the following:
Acoustic resistance Rw 38 dB with BA13 (the NRA2000 imposes 35 dB)

### Example 4

### Floor

Flooring: Floating flooring.
Resilient material: Ashur parquet
Floor panel/acoustic and structural roles (panel according to the invention)
   1st longitudinal layer—100% wood
   2nd transverse layer—50% wood/50% mineral wool
   3rd longitudinal layer—50% wood/50% mineral wool
   4th transverse layer—50% wood/50% mineral wool
   5th longitudinal layer—50% wood/50% mineral wool
   6th transverse layer—50% wood/50% mineral wool
   7th longitudinal layer—100% wood
Suspended false ceiling: Plasterboard on metal rail

The performance achieved with such a panel are the following:
Acoustic resistance Rw=39 dB with BA13 (the NRA2000 imposes 40 dB)
Reach=7 m (on 2 supports, under operation load of 150 kg/m² and a bending of 1/500)

### Example 5

### Inclined Roof

Cover: Any type of cover+battens and counter-battens.
Protection/tightness: Screen under roof such as a HPV rain screen.
Inclined panel/thermal, acoustic and structural roles (panel according to the invention)
   Structural wafer:
      1st longitudinal layer—100% wood
      2nd transverse layer—50% wood/50% mineral wool
      3rd longitudinal layer—50% wood/50% mineral wool
      4th transverse layer—50% wood/50% PSEG
      5th longitudinal layer—50% wood/50% PSEG
      6th transverse layer—50% wood/50% PSEG
      7th longitudinal layer—100% wood
   Insulating wafer:
      8th transverse layer—20% wood/80% PSEG
      9th longitudinal layer—20% wood/80% PSEG
      10th transverse layer—20% wood/80% PSEG
      11th longitudinal layer—25% wood/75% mineral wool
Suspended false ceiling: Plasterboard on metal rail.

The performance achieved with this panel are:
Heat Resistance: 5.91 m²·K/W
Heat conductivity: 0.17 W/m²·K (the new RT2012≦0.17 W/m²·K)
Acoustic resistance Rw=40 dB (with BA13) (the NRA2000 imposes 30 dB)
Reach=7 m (on 2 supports, under permanent operation and weather loads of 150 kg/m² and a bending of 1/500)

The panels can also be used in addition as a thermal addition to an existing structure, as in the case of facing renovation operation.

In this case, the thermal performance of the layers will be favored and the mesh of the structural strips will be sized strips (% of structural strips in each layer) such as to ensure:
the mechanical strength of the panel,
the transfer of force generated by the outer cladding to the supporting wall.

The materials used for the panel according to the invention can be chosen among the following ones:

For the structural strips can be chosen a wood among softwood such as spruce, fir, Douglas fir, or also a light metal such as aluminum, a composite material, resins. The strips can be solid or hollow.

Depending on the required thermal performance, associated with the acoustic, fire and economic constraints, several insulating products have been selected. The insulating products are used in the form of strips, for example of widths that are a multiple of 150 mm (150, 300, 450 and 600 mm) and thicknesses of 30 and 45 mm.

Glass wool is used as heat and sound insulation.

Its density is 70 kg/m³, its heat conductivity is 0.030 W/m·K, its vapor-diffusion resistance coefficient μ is 1.2, and its specific heat is 1030 J/(kg·K)

Its reaction to fire is classified as M0, and A2 S1 d0 according to Euroclass NF EN 13501-1. Such a reaction to fire corresponds to materials that can be qualified as “non-flammable” according to the French standard, which corresponds at least to the classification A2 S1 of Euroclass.

Rock wool can be used as heat insulation, but is particularly popular as sound insulation.

Its density is 100 to 150 kg/m³, its heat conductivity is 0.036 to 0.038 W/mK, its vapor-diffusion resistance coefficient μ is 1, and its specific heat is 1030 J/(kg·K).

Its reaction to fire is classified as combustible and A1 according to Euroclass EN 13501-1. It is thus especially non-flammable.

Graphitized expanded polystyrene (PSEG) is used as heat insulation. It is formed of pentane (mixture of mixed isomers) and 98% entrapped air. Insulating materials such as cellulose wadding are also suitable.

The density of PSEG is 20 kg/m³, its heat conductivity is 0.031 to 0.032 W/m·K, its vapor-diffusion resistance coefficient μ is 60, and its specific heat is 1450 J/(kg·K).

Its reaction to fire is classified as M4 and E according to Euroclass NF EN 13501-1 or M1 for flame-retardant expanded polystyrene (EPS).

Wood fiber can be used as heat and acoustic insulation, although its heat-insulation performance is slightly less good. It has a good inertia (summer/winter comfort), and it is formed of 98% wood fibers (softwood fibers felting) and paraffin (or polyolefin).

Its density ranges from 80 kg/m³ to 150 kg/m³, the heat conductivity is 0.039 to 0.042 W/m·K, the vapor-diffusion resistance coefficient μ is 5, and its specific heat is 2100 J/(kg·K).

Its reaction to fire is classified as M4 and E according to Euroclass NF EN 13501-1.

There exist materials, referred to as “wood wool”, with a density lower than 80 kg/m³.

Furthermore, the thermal performances of a building are closely linked to the overall inertia present in the latter. This inertia contributes to improving the “summer/winter comfort”; thus, materials providing this function can be integrated into the inner layers of the panels according to the invention. These filler materials also permit to improve the acoustic performances and, depending on their nature, to contribute to the fireproof rating and the fire stability of the panels. Among these materials can be found plaster (natural gypsum), cellulose wadding (paper recycling) or wood chips, used for example in a 15 mm thickness.

The density of plaster is 1250 kg/m³, the heat conductivity is 0.320 W/m·K, its vapor-diffusion resistance coefficient μ is 13, and its specific heat is 1265 J/(kg·K); it permits to obtain a noise reduction of 31 dB(A).

By combining specific heat and density, a volumetric thermal inertia of about 1500 kJ/m3·K is obtained, which, for a 30 mm thick strip gives a thermal inertia of 45 kJ/m²·K; the highly insulating materials such as those described above often have a much lower thermal inertia, and it may therefore be interesting for a panel to combine several insulating layers, forming an insulating wafer, and several layers having a high inertia, forming an inertia wafer. Since the wood has a volumetric thermal inertia in the range of 1000 kJ/m³·K, just somewhat lower than that of plaster, a 100% wood layer may be preferred, somewhat less efficient in inertia, but which also provides a good structural resistance.

The reaction to fire of plaster is classified as M0, and A2 s1 d0 according to Euroclass NF EN 13501-1, this material can also be classified as non-combustible, and especially non-flammable.

The water-vapor tightness is obtained by implementing a vapor barrier film on the inner surface of the panels. The sealing of the edges and connections with the woodwork is ensured by means of suitable adhesive strips.

The products have a maximum permeability of 0.005 g/m²·mm Hg, and a minimum thickness of 100 μm, in compliance with DTU 31.2.

Depending on the “resistance to water-vapor diffusion” specific to each filler product (insulation and inertia) a panel according to the invention is formed of and depending on the results of the calculation of the water-vapor pressure curves, it can be considered to omit the vapor barrier.

As regards the protection against rain, according to the classification of the vertical wall (DTU 20.1) and depending on the type of the outer siding applied against the panels according to the invention, and water-tightness independent from the outer coating may be required. A rain-screen film can ensure the water-tightness of the building.

The products have a maximum permeance of 0.5 g/m² mm Hg in compliance with DTU 31.2.

The outer sidings applied against the walls according to the invention are separated into two families:
strip- or plate-like sidings, fastened to a secondary frame incorporating a ventilated air strip,
coatings applied directly against the panels.

In the first case, the water-tightness is ensured by a rain-screen positioned at the level of the ventilated air strip.

The outer sidings are secured to a discontinuous support of the type secondary wooden frame support. The distances between centers and the cross-section of the framing elements depend on the type of materials applied against the facing (in compliance with the provisions of DTU or the technical advice of the manufacturers).

Examples of outer sidings that can be associated with the walls according to the invention:
Cladding of solid wooden strips (DTU 41.2)
Cladding of synthetic material strips
Cladding of metal panels,
high pressure decorative laminated panels
Shingle-like wood flake cladding
Flake cladding made of terracotta,
Thin stone fastened wall coverings

The coatings such as applied coatings associated with a fiber reinforcement can be applied against the last 100% insulating layer of the panels according to the invention. Depending on the recommendations for the existing outer surface coating systems, the supporting insulation would be of wood fiber (minimum 60 mm), rock wool (minimum 40 mm) or polystyrene (minimum 30 mm).

The advantage provided by the present invention primarily resides in that it permits to provide panels having the desired properties for a plurality of applications, from a few elemental components, which are the structural strips and the filler strips, while achieving excellent properties.

Although the invention has been described according to a particular embodiment, it is in no way limited thereto, and variations can be made, as well as combinations of the variants described, without departing from the scope of the present invention.

1-9. (canceled)

10. Multi-ply panel for a wall, a floor, a ceiling, or an inclined surface of a building, comprising:
a stack of layers, at least one layer being comprised of parallel structural strips of a first material, and
filler strips arranged between the structural strips, said filler strips being comprised of a different material than said first material, the different material and said first material being selected for at least one of heat insulation, sound insulation, thermal inertia and fire-resistance, wherein at least one filler strip is rigid and comprised of an insulating material with a heat conductivity of less than 0.038 W/mK, and wherein at least one other filler strip is comprised of a material different from a material of said at least one filler strip.

11. Panel according to claim 10, wherein said insulating material is selected from at least one of a group consisting of: glass wool, rock wool or, white or expanded polystyrene, and graphitized expanded polystyrene.

12. Panel according to claim 10, further comprising another filler strip comprised of an inertia material having a thermal inertia higher than 1000 kJ/m 3·K.

13. Panel according to claim 12, wherein said inertia material is selected from at least one of a group consisting of: wood, plaster, cellulose wadding and wood flakes.

14. Panel according to claim 10, further comprising a filler strip comprised of a sound insulation material.

15. Panel according to claim 14, wherein said sound insulation material is selected from at least one of a group consisting of rock wool or and wood fibers.

16. Panel according to claim 10, further comprising another filler strip comprised of non-combustible material.

17. Panel according to claim 16, wherein said non-combustible material is selected from at least one of a group consisting of plaster and rock wool.

18. Panel according to claim 10, further comprising a layer for technical networks, wherein spaces remain between the structural strips said technical networks passing through said spaces.
